(19) United States
(12) Patent Application Publication
(10) Pub. No.: US 2006/0072091 A1
(43) Pub. Date: Apr. 6, 2006

(54) Exposure apparatus

(76) Inventor: Seima Kato, Utsunomiya-shi (JP)

Correspondence Address: MORGAN & FINNEGAN, L.L.P., 3 WORLD FINANCIAL CENTER, NEW YORK, NY, 10281-2101, US

(21) Appl. No.: 11/239,859

(22) Filed: Sep. 29, 2005

(30) Foreign Application Priority Data
Oct. 1, 2004 (JP) 2004-289736

(51) Int. Cl. G03B 27/42; G02B 26/00

(52) U.S. Cl. 355/53; 359/237

(57) ABSTRACT

An exposure apparatus includes plural light modulators that are arranged in parallel, each of which includes an element for modulating a phase distribution of incident light by providing the incident light with a phase difference, and plural projection optical systems that are arranged in parallel, each of which corresponds to each light modulator and projects a pattern formed by a corresponding one of the light modulators onto an object to be exposed.

### BACKGROUND OF THE INVENTION

The present invention relates to maskless exposure that dispenses with a photo-mask or reticle as an original, and utilizes a light modulator (also referred to as a spatial light modulator) that provides the incident light with plural phase differences modifies the light. The present invention is, suitable for example, for an exposure apparatus that exposes a large screen, such as a liquid crystal panel.

A projection optical system has been conventionally used to expose a mask pattern onto a substrate on which a photosensitive agent is applied in manufacturing a semiconductor device and a liquid crystal panel. However, as the finer processing to the mask pattern and a larger mask size are demanded with the improved integration and increased area of the device, an increase of the mask cost becomes problematic. Accordingly, the maskless exposure that dispenses with the mask for exposure has called attentions.

One exemplary attractive maskless exposure is a method for projecting a pattern image onto a substrate using a phase-modulation type light modulator. The light modulator is a parallel-connected type device, and the number of pixels per unit time may possibly be increased enormously. The phase modulation needs a minute displacement of a mirror, and thus is suitable for high-speed operation. In particular, a grating light valve (“GLV”) type light modulator that uses a modulated pattern of a diffraction grating is suitable for a large amount of data transfers, and a maskless exposure apparatus that transfers enormous data amount. The maskless exposure apparatus that uses the light modulator instead of the mask to modulate the exposure light in accordance with a desired pattern, and condenses the pattern via a projection optical system, and forms the pattern on the substrate. GLV is disclosed, for example, in Optics Letters, Vol. 17, pp. 688-690 (1992).

Referring now to FIGS. 10A and 10B, a description will be given of an operational principle of a conventional GLV 20. Here, FIG. 10A shows a relationship between the section of the GLV 20 and a phase difference when the GLV 20 turns off. FIG. 10B shows a relationship between the section of the GLV 20 and a phase difference when the GLV 20 turns on.

Each element in the GLV 20 has a pair of catoptric bands or ribbons 21, and each pixel 23 includes three elements 22. The GLV 20 is a reflection-type phase modulator that has plural pixels 23 arranged in parallel. One of ribbons 21 in each element 22 is connected to a switch (not shown), and configured to vary its level, for example, when the voltage is applied to it.

When the switch turns off, as shown in FIG. 10A, all the ribbons 22 have the same level. When the switch turns on, as shown in FIG. 10B, the ribbons 21 fall alternately by a quarter of the irradiation wavelength, and the reflected light have a phase difference of 180° between two adjacent ribbons 21. When the switch turns off, only the 0th order diffracted light is reflected since the reflected light is reflected while its phase is not modulated. On the other hand, when the switch turns on, the reflected light is phase-modulated and the ±1st order diffracted lights are reflected.

Referring to FIGS. 11A and 11B, a description will be given of control over the diffracted light using the GLV 20. Here, FIG. 11A is a schematic view for explaining the control over the diffraction light using the GLV 20. As shown in FIG. 11A, a filter 32 that blocks the 0th order light is provided between a lens 31 and the GLV 20. When the switch turns off, no light is incident upon the lens 31. When the switch turns on, the ±1st order diffracted lights are incident upon the lens 31. A maskless exposure apparatus that controls the exposure light is configured when it installs the GLB 20 instead of the mask and the lens 31 is regarded as the projection optical system.

In the maskless exposure apparatus equipped with the GLV 20 shown in FIG. 11A, the projection optical system 31 should have a wide diameter to accept the ±1st order diffracted lights, causing a big apparatus. In addition, two lights incident upon the projection optical system 31 may interfere with each other and result in an unnecessary pattern. On the other hand, in a conceivable combination of the GLV 20 and an oblique incident illumination shown in FIG. 11B, when the switch turns off, this configuration does not supply the light to the lens 31 since only the 0th order light occurs. When the switch turns on, the ±1st order diffracted lights occur and one of them, which is the −1st order diffracted light in FIG. 11B, enters the lens 31 by adjusting the irradiation angle onto the GLV. As a result, a small size is enough for the projection optical system 31. In addition, only one light entering the projection optical system 31 realizes the high-quality exposure that resolves only a predetermined pattern. However, a problem of reduced exposure dose and thus lowered throughput occurs because one of the ±1st order diffracted lights is not used.

Other prior art include U.S. Pat. No. 6,025,859, and J. W. Goodman, Introduction to Fourier Optics 2nd ed., ISBN 0-07-114257-6.

There is a demand for large area exposure using the GLV, for example, for a liquid crystal panel, so as to increase the throughput. Even in this case, a smaller size of the exposure apparatus is preferable.

### BRIEF SUMMARY OF THE INVENTION

Accordingly, it is an exemplary object of the present invention to provide an exposure apparatus that utilizes a light modulator, preferably has a small size, and improves the throughput, and a device manufacturing method using the same.

An exposure apparatus according to one aspect of the present invention includes plural light modulators that are arranged in parallel, each of which includes an element for modulating a phase distribution of incident light by providing the incident light with a phase difference, and plural projection optical systems that are arranged in parallel, each of which corresponds to each light modulator and projects a pattern formed by a corresponding one of the light modulators onto an object to be exposed.

A device manufacturing method according to still another aspect of the present invention includes the steps of exposing an object using the above exposure apparatus, and developing the object that has been exposed. Claims for a device manufacturing method for performing operations similar to that of the above exposure apparatus cover devices as intermediate and final products. Such devices include semiconductor chips like an LSI and VLSI, CCDs, LCDs, magnetic sensors, thin film magnetic heads, and the like.

Other objects and further features of the present invention will become readily apparent from the following description of the preferred embodiments with reference to the accompanying drawings.

### BRIEF DESCRIPTION OF THE DRAWINGS

FIG. 1 is a schematic block diagram of an exposure apparatus according to one embodiment of the present invention.

FIG. 2 is a detailed schematic perspective view between GLVs and projection optical systems in the exposure apparatus shown in FIG. 1.

FIG. 3 is a schematic plane view showing a relationship between the projection lenses and the exposure areas in the projection optical systems shown in FIG. 2.

FIG. 4 is a schematic plane view showing an arrangement of the projection lenses in the projection optical system shown in FIG. 2.

FIG. 5 is a schematic perspective view showing a relationship between one GLV and the projection lens in one projection optical system shown in FIG. 2.

FIG. 6A is a schematic plane view for explaining a cutout of the projection lens shown in FIG. 5 near the pupil surface in the projection optical system.

FIG. 6B is a schematic plane view of the projection lens shown in FIG. 5 that has been cut.

FIG. 7 is a schematic plane view for explaining a relationship between the diffracted light and the projection lens arranged outside the pupil surface of the projection optical system shown in FIG. 2.

FIG. 8 is a flowchart for explaining a device manufacturing method using the exposure apparatus shown in FIG. 1.

FIG. 9 is a detailed flowchart for Step 4 of wafer process shown in FIG. 8.

FIG. 10A shows a relationship between the section of a conventional GLV that turns off and the phase differences.

FIG. 10B shows a relationship between the section of a conventional GLV that turns on and the phase differences.

FIG. 11A is a schematic view for explaining control of the diffracted light using the conventional GLV.

FIG. 11B is a schematic view for explaining control of the diffracted light using the conventional GLV.

### DETAILED DESCRIPTION OF THE PREFERRED EMBODIMENTS

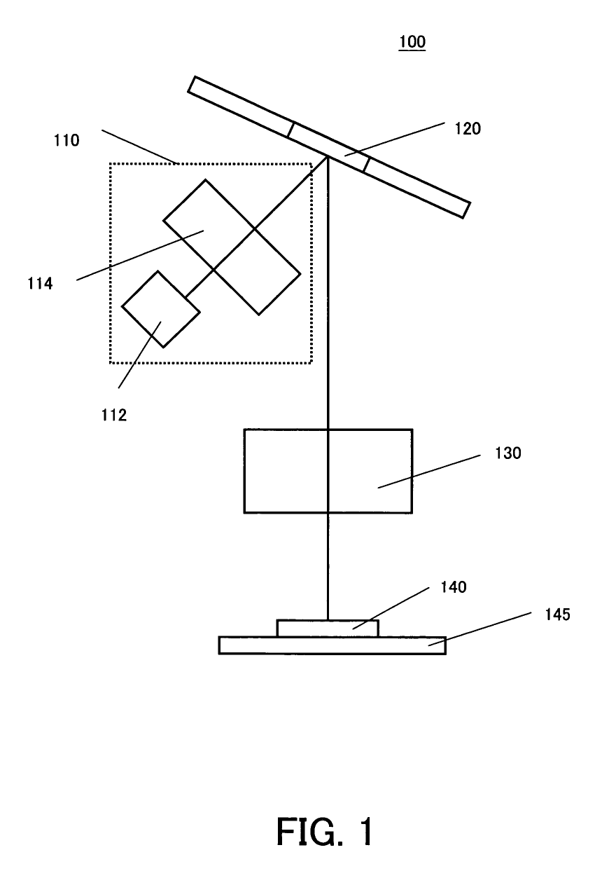

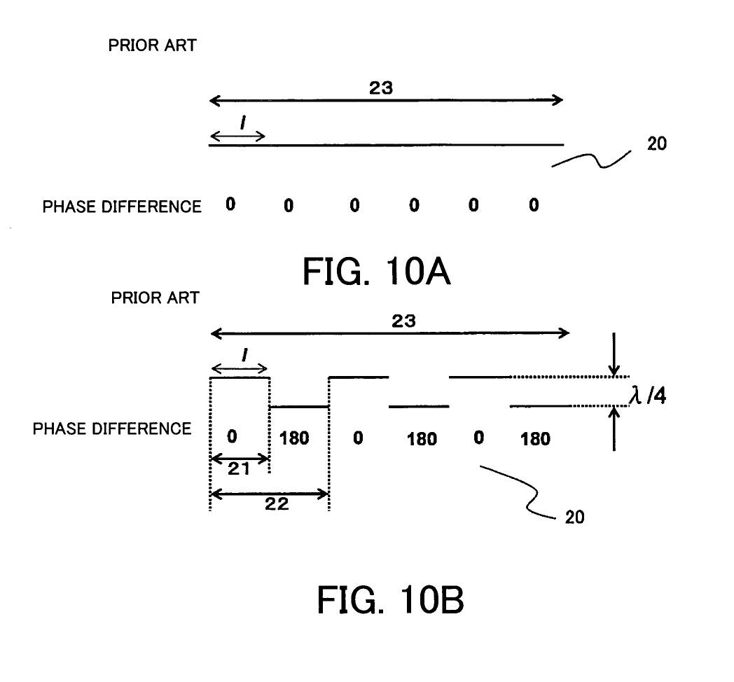

Referring to FIG. 1, a description will be given of the exposure apparatus 100 according to one embodiment of the present invention. FIG. 1 is a schematic block diagram of the illustrative exposure apparatus 100. The exposure apparatus 100 includes an illumination apparatus 110 that illuminates a GLV 120, the GLV 120 that has a similar structure as that of the GLV 20 shown in FIGS. 10A and 10B, a projection apparatus 130 that projects onto a plate 140 the diffracted light generated from the illuminated GLV 120, and a stage 145 that supports the plate 140.

The exposure apparatus 100 is suitable for a submicron or quarter-micron lithography process, and this embodiment discusses a step-and-scan exposure apparatus (also referred to as a “scanner”). The “step-and-scan manner”, as used herein, is an exposure method that exposes a pattern onto a wafer by continuously scanning the wafer relative to the GLV 120, and by moving, after a shot of exposure, the wafer stepwise to the next exposure area to be shot. Of course, the exposure apparatus 100 is applicable to a step-and-repeat exposure apparatus (also referred to as a “stepper”).

The illumination apparatus 110 includes a light source section 112 and an illumination optical system 114, and illuminates the GLV 120 that is controlled in accordance with a circuit pattern to be transferred.

The light source section 112 uses, for example, a light source such as an ArF excimer laser with a wavelength of approximately 193 nm, a KrF excimer laser with a wavelength of approximately 248 nm, and an an F₂ laser having a wavelength of about 157 nm. However, the type of the light source is not limited or the number of light sources is not limited. When using a laser, the light source section 112 preferably uses a light shaping optical system that turns the collimated light from the laser light source into a desired beam shape, and an incoherently turning optical system that turns a coherent laser beam into an incoherent one.

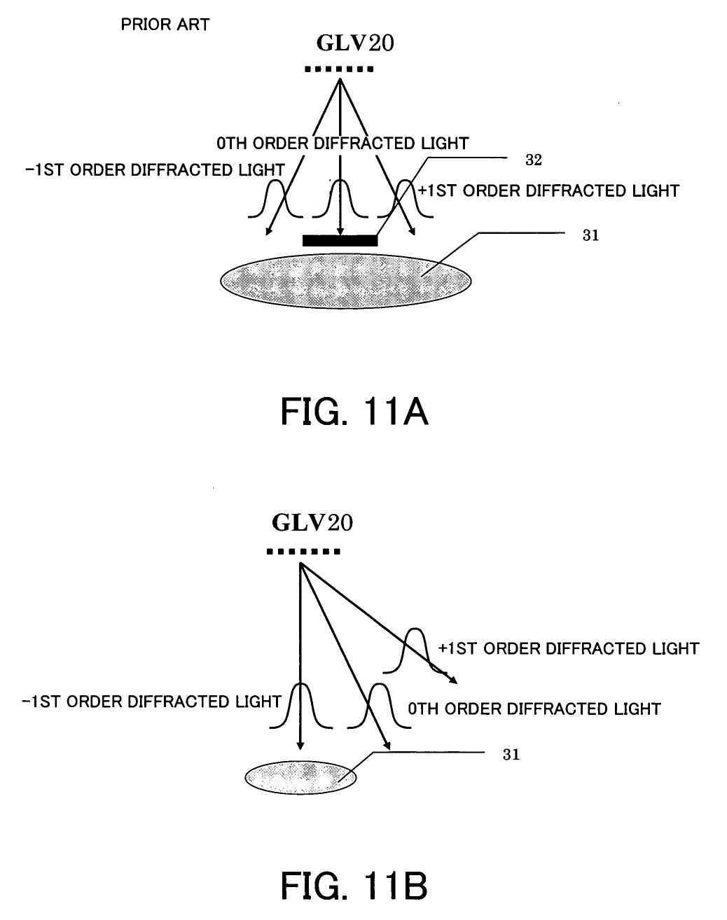

The illumination optical system 114 is an optical system that illuminates the GVL 120, and includes a lens, a mirror, an optical integrator, a stop and the like, for example, a condenser lens, a fly-eye lens, an aperture stop, a condenser lens, a slit, and an imaging optical system in this order. The illumination optical system 114 can use any light regardless of whether it is axial or non-axial light. The light integrator may include a fly-eye lens or an integrator formed by stacking two sets of cylindrical lens array plates (or lenticular lenses), and can be replaced with an optical rod or a diffractive optics. A method for illuminating the GLV may be perpendicular irradiation shown in FIG. 11A, or the oblique irradiation shown in FIG. 11B. This embodiment uses the perpendicular irradiation.

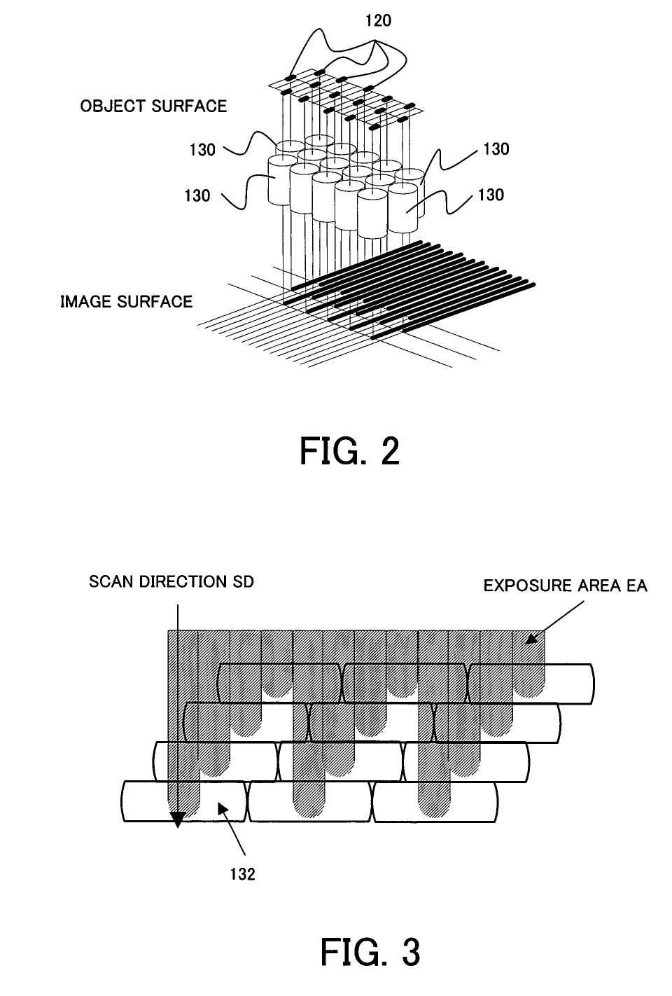

The GLV 120 whose switch is electrically turned on and off from the outside controls the diffracted light, and is supported and driven by a GLV stage (not shown). The diffracted light is projected onto the plate 140 through the projection optical system 130. The GLV 120 and the plate 140 have an optically conjugate relationship. Since the exposure apparatus 100 of this embodiment is a scanner, the GLV 120 repeats turning on and off while the exposure apparatus scans the plate 140 at a speed ratio corresponding to a reduction ratio, transferring the pattern of the GLV 120 onto the plate 140. As described later with reference to FIG. 2, this embodiment provides N pieces of GLVs.

Each projection optical system 130 may use a dioptric optical system that includes only plural lens elements, a catadioptric optical system comprised of a plurality of lens elements with at least one concave mirror, and a catoptric optical system including only mirrors, and so on. Any necessary correction of a chromatic aberration in the projection optical system 130 can use a plurality of lens elements made from glass materials having different dispersion or Abbe values, or arrange a diffraction optical element such that it disperses in a direction opposite to that of the lens element.

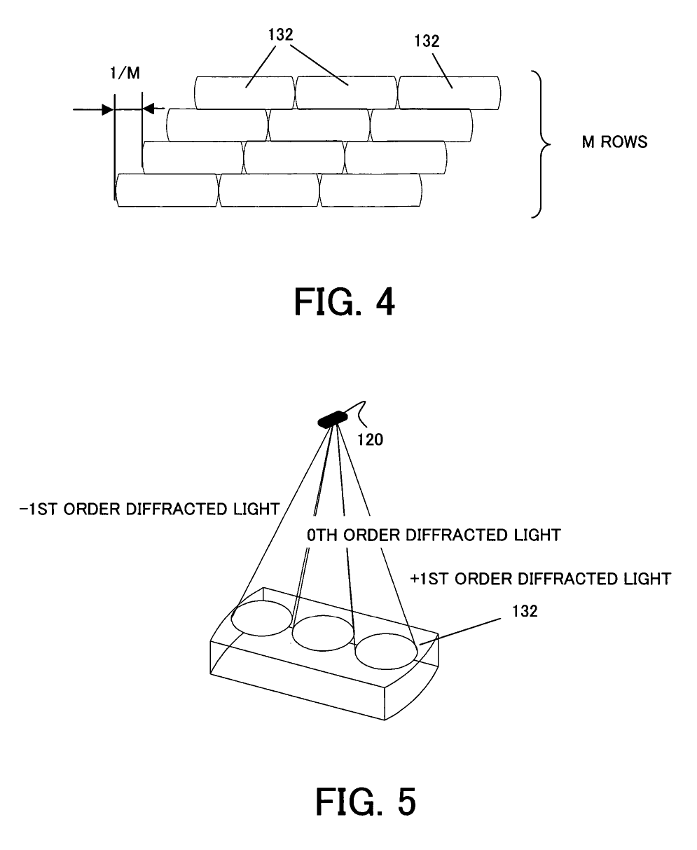

FIG. 2 is a schematic perspective view showing a relationship between the GLVs 120 and the projection optical systems 130. This embodiment arranges plural projection optical systems 130 for a block of scanning. This embodiment defines a scan direction SD as a row direction and a direction perpendicular to the scan direction SD as a column direction. The projection optical systems 130 are aligned with the row direction, but slightly shifted in the column direction. In the parallel exposure, an exposure area EA is defined as an area that one projection optical system 130 can expose by one scan. Two adjacent exposure areas EA should overlap each other. Therefore, as shown in FIG. 3, each line of the projection lenses 132 aligned with the row direction shifts by a width of the exposure area EA perpendicular to the scan direction SD. When the width of the exposure area EA is 1/M times the maximum diameter of the projection optical system 130 including the lens support mechanism, and M is the number of rows of projection optical systems 130 in the row direction, the projection lenses 132 adjacent in the column direction have overlapping exposure areas EA. M is a natural number in this embodiment. As a result, the projection lenses 132 are arranged like bricks as shown in FIG. 4. The number of projection lenses 132 in the row direction may be arbitrary.

This embodiment attempts to miniaturize the exposure apparatus 100 by partially eliminating a nonuse area upon which no diffracted lights are incident from each projection lens 132 that has originally a circular shape when viewed from the top, and by reducing the size of each projection optical system 130. In this embodiment, the size of the projection lens 132 should accept the ±1st order diffracted lights. All the lenses in the projection optical system 130 should have maximum diameters when the 0th order diffracted light is spatially separated from the ±1st order diffracted lights on the pupil of the projection lens 132 and the 0th order diffracted light is blocked while the 1st order diffracted light are transmitted during switching. In this case, the lens near the pupil should be about three times as large as the effective light diameter D of the diffracted light. The effective light diameter D of the diffracted light is a diameter of an area that obtains 90% or greater of the light intensity of each diffracted light. Therefore, the exposure apparatus 100 solves the problem of the large size of the exposure apparatus that uses the GLV 120 for the parallel exposure.

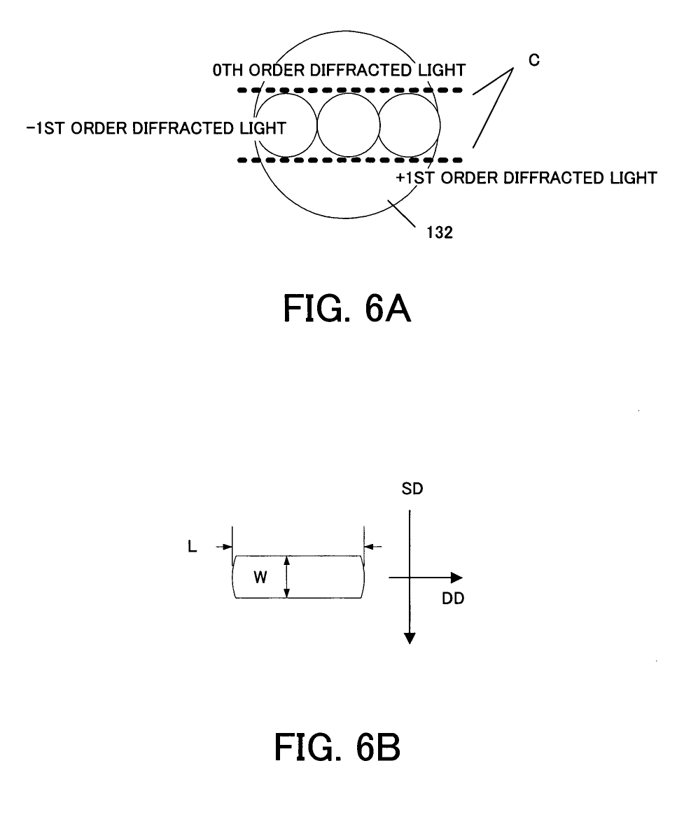

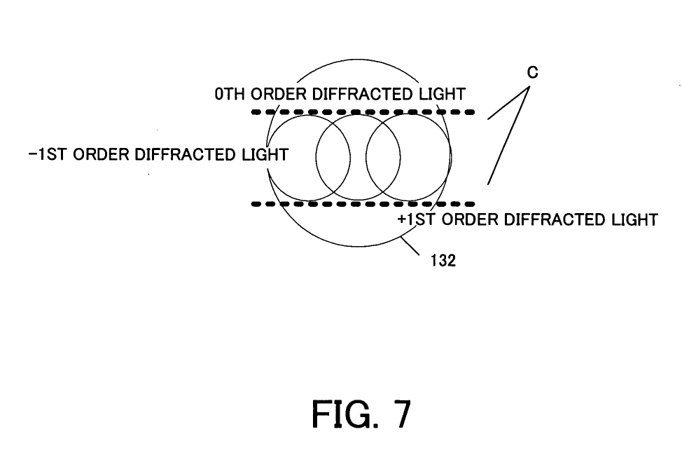

Since the 0th order diffracted light and the ±1st order diffracted lights generated from the GLV 120 spread in one direction, the area in the lens 132, which uses the lights has a linear shape. Therefore, there are many nonuse areas in the lens 132, upon which no lights are incident. The lens 132 from which the nonuse area is eliminated is configured as shown in FIG. 5. The projection optical system 130 of this embodiment spatially separates the 0th order diffracted light from the ±1st order diffracted lights, and includes both the ±1st order diffracted lights. Therefore, the nonuse areas area removed by cut lines C shown in FIGS. 6A and 7. Here, FIG. 6A is a schematic plane view of the projection lens 132 near the pupil surface, while FIG. 7 is a schematic plane view of the projection lens 132 slightly apart from the pupil surface.

FIG. 6B is a schematic plane view of the projection lens 132 cut by the cut lines C shown in FIG. 6A. As illustrated, the length L: the width W=3: 1 is met in the cut projection lens 132. The scan exposure that uses the parallel-arranged plural projection optical system 130 each equipped with such a projection lenses 132 can efficiently expose a large area while maintaining the size of the exposure apparatus 100.

Assume, in FIG. 6B, the scan direction SD and the diffraction direction DD, with which centers of the diffracted lights are aligned (or the diffraction direction DD which is perpendicular to the scan direction SD). The width of the scan direction SD may be between the effective light diameter D of the 1st order diffracted light and the diameter shown in FIG. 6A, such as about 3.3 times the effective light diameter D, which is slightly greater than a sum of three effective light diameters of the three diffracted lights (it is preferably “slightly greater” for a practical margin). Similarly, in this embodiment the width L of the diffraction direction DD may be the diameter shown in FIG. 6A, such as about 3.3 times the effective light diameter D, which is slightly greater than a sum of three effective light diameters of the three diffracted lights (it is preferably “slightly greater” for a practical margin). When the oblique incidence is considered, it may be equal to or greater than the effective light diameter D of the 1st order diffracted light if there is a proper blocking means. For example, the length L may be slightly greater than a sum of the effective light diameter D of two diffracted lights, e.g., the 0th and 1st order diffracted lights, such as about 2.2 times the effective light diameter D, which is slightly greater than a sum of three effective light diameters of the three diffracted lights (it is preferably “slightly greater” for a practical margin).

The plate 140 is an exemplary object to be exposed, such as a wafer and a LCD, and photoresist is applied to the plate 140. A photoresist application step includes a pretreatment, an adhesion accelerator application treatment, a photoresist application treatment, and a pre-bake treatment. The pretreatment includes cleaning, drying, etc. The adhesion accelerator application treatment is a surface reforming process so as to enhance the adhesion between the photoresist and a base (i.e., a process to increase the hydrophobicity by applying a surface active agent), through a coat or vaporous process using an organic film such as HMDS (Hexamethyl-disilazane) The pre-bake treatment is a baking (or burning) step, softer than that after development, which removes the solvent.

The stage 145 supports the plate 140. The stage 145 may use any structure known in the art, and a detailed description of its structure and operations will be omitted. For example, the stage 145 uses a linear motor to move the plate 140 in the XY directions orthogonal to the optical axis. The GLV 120 and plate 140 are, for example, scanned synchronously, and positions of the GLV stage (not shown) and stage 145 are monitored, for example, by a laser interferometer and the like. The GLV 120 is turned on and off in accordance with driving of the stage 145. The stage 145 is installed on a stage stool supported on the floor and the like, for example, via a damper. The GLV stage and the projection optical system 130 are provided, for example, on a barrel stool (not shown) that is supported on a base frame placed on the floor, for example, via a damper.

In exposure, the light emitted from the light source section 112, for example, Koehler-illuminates the GLV 120 through the illumination optical system 114. The light that has been reflected by the GLV 120 and reflects the pattern forms an image on the plate 140 through the projection optical system 130. The GLV 120 in the exposure apparatus 100 does not restricts the NA or loses the light intensity. Therefore, the exposure apparatus 100 can provide high-quality devices (such as semiconductor devices, LCD devices, image pick-up devices (such as CCDs), and thin film magnetic heads) with excellent work efficiency.

While this embodiment introduces the step-and-scan manner, another manner is applicable. For example, rather than the wafer is stepped after exposure to one shot ends, the other manner 1) exposes only first part within the one shot and steps the wafer, 2) similarly exposes only the first part in the next shot and repeats this procedure for all the shots, and 3) returns to the initial shot, and repeats the similar action for second part different from the first part.

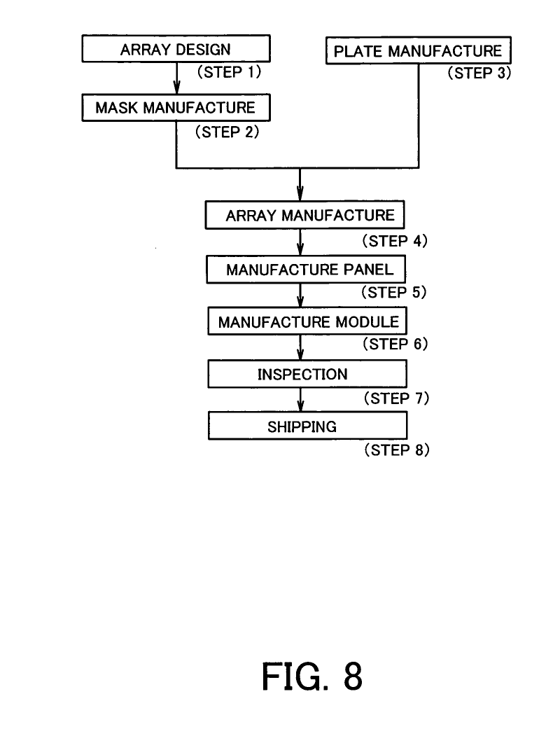

A description will now be given of an embodiment of a device manufacturing method using the exposure apparatus 100. FIG. 8 is a flowchart for explaining a manufacturing method of a liquid crystal panel. Step 1 (array design) designs a liquid crystal array circuit. Step 2 (mask manufacture) sets the GLV exposure operation or an input signal to the GLV in order to form a designed circuit pattern. Step 3 (plate manufacture) manufactures a glass plate. Step 4 (array manufacture), which is also referred to as a “pretreatment”, forms actual circuitry on the glass plate through the photolithography using the GLV and plate that have been prepared. Step 5 (panel manufacture), which is also referred to as a “posttreatment”, seals a back peripheral that has been pasted together with a color filter that has been manufactured by a separate step, and implants liquid crystal. Step 6 (inspection) performs various tests, such as a performance test and a durability test, for a liquid crystal panel module that has assembled tabs and backlight and aged after Step 5. A liquid crystal panel is finished and shipped through these steps (Step 7).

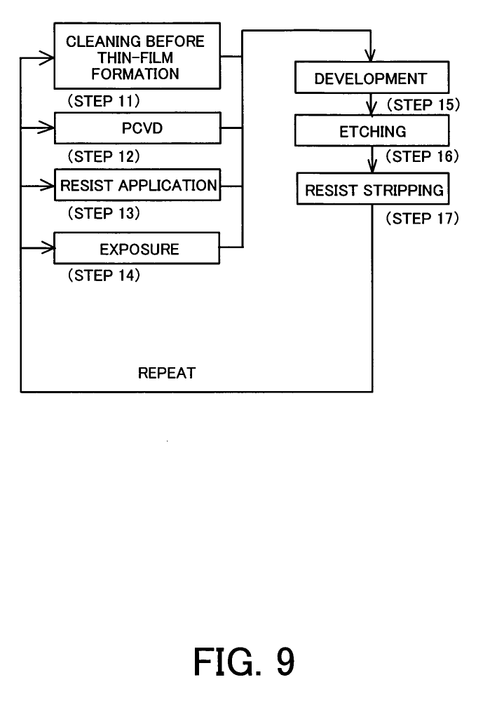

FIG. 9 is a detailed flowchart for the array manufacture in Step 4. Step 11 (cleaning before thin-film formation) cleanses the glass plate as a pretreatment prior to forming a thin film on its surface. Step 12 (PCVD) forms a thin film on the surface of the glass plate. Step 13 (resist application) applies desired resist to the surface of the glass plate, and bakes it. Step 14 (exposure) exposes the array pattern onto the glass plate using the exposure apparatus 100. Step 15 (development) develops the exposed glass plate. Step 16 (etching) etches out parts other than developed resist images. Step 17 (resist stripping) strips disused resist after etching. These steps repeat until multi-layer circuit patterns are formed onto the plate.

Furthermore, the present invention is not limited to these preferred embodiments and various variations and modifications may be made without departing from the scope of the present invention.

The present invention can provide an exposure apparatus that improves the throughput by using the light modulator and a device manufacturing method using the exposure apparatus.

This application claims a foreign priority benefit based on Japanese Patent Applications No. 2004-289736, filed on Oct. 1, 2004, which is hereby incorporated by reference herein in its entirety as if fully set forth herein.

What is claimed is:

1. An exposure apparatus comprising:
plural light modulators that are arranged in parallel, each of which includes an element for modulating a phase distribution of incident light by providing the incident light with a phase difference; and
plural projection optical systems that are arranged in parallel, each of which corresponds to each light modulator and projects a pattern formed by a corresponding one of said light modulators onto an object to be exposed.

2. An exposure apparatus according to claim 1, wherein the element includes plural displaceable light reflective bands, and
wherein the light modulator has plural pixels each including the at least one element.

3. An exposure apparatus according to claim 1, wherein each projection optical system includes an optical element that has a length between an effective light diameter of a diffracted light of a predetermined order and 3.3 times the effective light diameter in a direction perpendicular to a diffraction direction with which diffracted lights align on a pupil.

4. An exposure apparatus according to claim 1, wherein each projection optical system includes an optical element that has a length between an effective light diameter of a diffracted light of a predetermined order and 3.3 times the effective light diameter in a diffraction direction with which diffracted lights align on a pupil.

5. An exposure apparatus according to claim 1, wherein each projection optical system includes an optical element that has a length between an effective light diameter of a diffracted light of a predetermined order and 2.2 times the effective light diameter in a diffraction direction with which diffracted lights align on a pupil.

6. An exposure apparatus according to claim 1, wherein each plural projection optical systems has a width of one exposable area in a diffraction direction with which diffracted lights align, which width is 1/M times a maximum diameter of the projection optical system, and M projection optical systems are arranged in a direction perpendicular to the diffraction direction.

7. An exposure apparatus according to claim 6, wherein said projection optical systems area arranged by a width of the exposable area in the diffraction direction.

8. A device manufacturing method comprising the steps of:
exposing an object using the exposure apparatus according to claim 1; and
developing the object that has been exposed.
